(19) United States
(12) Patent Application Publication
(10) Pub. No.: US 2026/0196562 A1
(43) Pub. Date: Jul. 9, 2026

(54) LITHIUM-ION BATTERY

(71) Applicant: TOYOTA JIDOSHA KABUSHIKI KAISHA, Toyota-shi (JP)

(72) Inventor: Kyosuke YOSHIDA, Susono-shi (JP)

(73) Assignee: TOYOTA JIDOSHA KABUSHIKI KAISHA, Toyota-shi (JP)

(21) Appl. No.: 19/413,526

(22) Filed: Dec. 9, 2025

(30) Foreign Application Priority Data
Jan. 6, 2025 (JP) 2025-001767

(51) Int. Cl. H01M 10/0568; H01M 4/02; H01M 4/134; H01M 4/38; H01M 10/0525; H01M 10/0569

(52) U.S. Cl. CPC H01M 10/0568; H01M 4/134; H01M 4/386; H01M 10/0525; H01M 10/0569; H01M 2004/027

(57) ABSTRACT

A lithium-ion battery of the present disclosure includes an anode active material layer, a separator layer, and a cathode active material layer in the stated order, and the anode active material layer, the separator layer, and the cathode active material layer are impregnated with an electrolyte solution. The anode active material layer contains a silicon-based anode active material. The electrolyte solution contains (A) lithium bis(fluorosulfonyl)imide and (B) N,N-dimethyltrifluoromethanesulfonamide. A molar ratio of a component (A) to a component (B) is 1/16 or more and 1/4 or less.

### CROSS-REFERENCE TO RELATED APPLICATION

This application claims priority to Japanese Patent Application No. 2025-001767 filed on Jan. 6, 2025. The disclosure of the above-identified application, including the specification, drawings, and claims, is incorporated by reference herein in its entirety.

### BACKGROUND

### 1. Technical Field

The present disclosure relates to a lithium-ion battery.

### 2. Description of Related Art

There are known electrolyte solutions for lithium-ion batteries containing lithium bis(fluorosulfonyl)imide (LiFSI).

For example, Japanese Unexamined Patent Application Publication (Translation of PCT Application) No. 2024-506963 (JP 2024-506963 A) discloses an electrochemical device including a cathode containing at least one transition metal oxide, and an electrolyte. The electrolyte contains a solvent containing N,N-dimethyltrifluoromethane-sulfonamide (DMTFSA, DMeTFSA), and lithium bis(fluorosulfonyl)imide (LiFSI) substantially dissolved in the solvent.

WO 2018/221346 discloses a lithium-ion secondary battery including an anode active material containing a material containing silicon as a constituent element, and an electrolyte solution containing a non-aqueous solvent containing a predetermined fluorinated ether compound, a predetermined chain sulfone compound, and a cyclic carbonate compound, and a supporting salt containing LiPF₆, lithium bis(fluorosulfonyl)imide (LiFSI), and lithium bis(oxalato) borate (LiBOB).

### SUMMARY

As described above, the related art discloses the electrochemical device such as a lithium-ion battery including the electrolyte solution containing LiFSI and DMeTFSA (JP 2024-506963 A), and the lithium-ion secondary battery including the silicon-based anode active material and the electrolyte solution containing LiFSI (WO 2018/221346).

The related art does not disclose a lithium-ion battery including a silicon-based anode active material and an electrolyte solution containing LiFSI and DMeTFSA. The present inventors have found that there is room for improvement in cycle characteristics of such a lithium-ion battery.

The present disclosure has an object to provide a lithium-ion battery with improved cycle characteristics.

The present inventors have found that the above issue can be addressed by the following measures.

### First Aspect

A lithium-ion battery includes an anode active material layer, a separator layer, and a cathode active material layer in the stated order.

The anode active material layer, the separator layer, and the cathode active material layer are impregnated with an electrolyte solution.

The anode active material layer contains a silicon-based anode active material.

The electrolyte solution contains (A) lithium bis(fluorosulfonyl)imide and (B) N,N-dimethyltrifluoromethanesulfonamide.

A molar ratio of a component (A) to a component (B) is 1/16 or more and 1/4 or less.

### Second Aspect

In the lithium-ion battery according to the first aspect, the molar ratio is 1/12 or more and 1/8 or less.

### Third Aspect

In the lithium-ion battery according to the first or second aspect, a total mass of the component (A) and the component (B) in the electrolyte solution is greater than a mass of each of other components contained in the electrolyte solution.

According to the present disclosure, it is possible to provide the lithium-ion battery with improved cycle characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of a lithium-ion battery of the present disclosure;

FIG. 2 is a graph showing discharge capacity retention rates and coulombic efficiencies at a 100th cycle for batteries of Examples 1 to 4;

FIG. 3 is a graph showing discharge capacity retention rates at a 100th cycle for batteries of Examples 3 and 4, Reference Example, and Comparative Examples 1 to 4;

FIG. 4 is a graph showing average coulombic efficiencies of batteries of Comparative Examples 5 to 8; and

FIG. 5 is a graph showing the average coulombic efficiencies of the batteries of Comparative Examples 5 to 8.

### DETAILED DESCRIPTION OF EMBODIMENTS

An embodiment of the present disclosure will be described below in detail. The present disclosure is not limited to the following embodiment, and various modifications may be made within the scope of the present disclosure.

### Lithium-Ion Battery

A lithium-ion battery of the present disclosure includes an anode active material layer, a separator layer, and a cathode active material layer in the stated order, and the anode active material layer, the separator layer, and the cathode active material layer are impregnated with an electrolyte solution. The anode active material layer contains a silicon-based anode active material. The electrolyte solution contains (A) lithium bis(fluorosulfonyl)imide and (B) N,N-dimethyltrifluoromethanesulfonamide. A molar ratio of a component (A) to a component (B) is 1/16 or more and 1/4 or less.

To improve the cycle characteristics of the battery, it is conceivable to increase the concentration of a lithium salt in the electrolyte solution. In this regard, according to investigations conducted by the present inventors, in a lithium-ion battery including a silicon-based anode active material and an electrolyte solution containing lithium bis(fluorosulfonyl)imide (LiFSI) and N,N-dimethyltrifluoromethanesulfonamide (DMeTFSA), the cycle characteristics of the battery were not sufficiently improved even though the concentration of the lithium salt (LiFSI) in the electrolyte solution was increased.

The reason for this is presumed to be as follows, without intending to be bound by any theory. That is, in a battery including an electrolyte solution, a solid electrolyte interface (SEI) may be formed at an interface between an anode active material and the electrolyte solution. It is believed that the SEI can suppress reductive decomposition of the electrolyte solution. In this regard, it is believed that the SEI may crack due to expansion and contraction of the silicon-based anode active material caused by charging and discharging the battery. It is believed that the function of the SEI to suppress the reductive decomposition of the electrolyte solution decreases, resulting in a decrease in cycle characteristics of the battery.

The present inventors have found that, in the above lithium-ion battery, the cycle characteristics of the battery can be improved when the molar ratio of LiFSI to DMeTFSA in the electrolyte solution is 1/16 or more and 1/4 or less, that is, the concentration of LiFSI in the electrolyte solution is relatively low.

Without intending to be bound by any theory, it is believed that this is because the relatively low concentration of LiFSI in the electrolyte solution containing LiFSI and DMeTFSA results in the formation of a good SEI that is less susceptible to cracking.

The battery of the present disclosure may be a liquid battery or a solid-state battery, and may particularly be a liquid battery. In the present disclosure, the “solid-state battery” refers to a battery that uses at least a solid electrolyte as the electrolyte. Therefore, the solid-state battery may use a combination of the solid electrolyte and a liquid electrolyte as the electrolyte.

The battery of the present disclosure may be a primary battery or a secondary battery, and may particularly be a secondary battery.

Each element constituting the lithium-ion battery of the present disclosure will be described below.

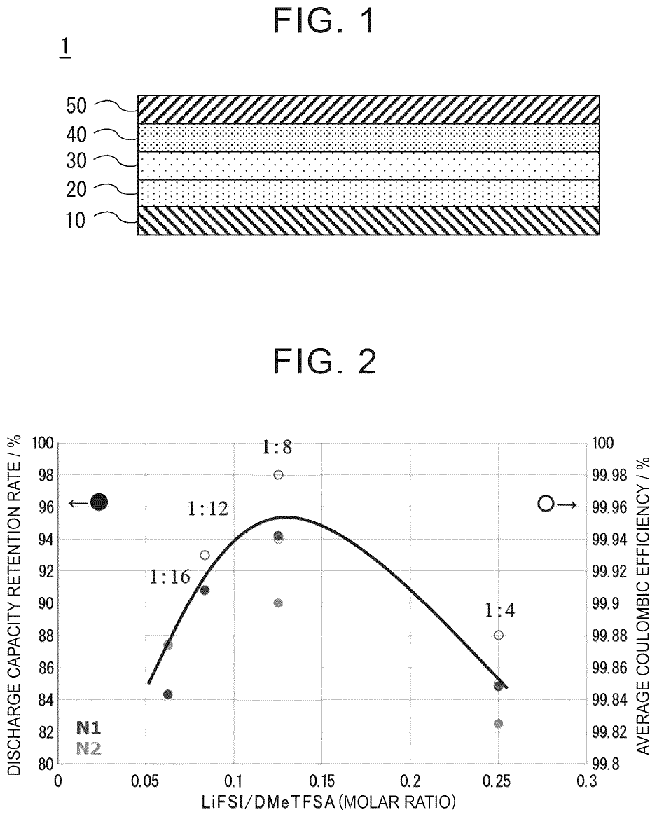

As illustrated in FIG. 1, a lithium-ion battery 1 of the present disclosure includes an anode active material layer 20, a separator layer 30, and a cathode active material layer 40 in the stated order.

### Anode Active Material Layer

In the lithium-ion battery of the present disclosure, the anode active material layer contains a silicon-based anode active material. The anode active material layer may optionally contain a conductive aid, a binder, etc.

### Silicon-Based Anode Active Material

As described above, the silicon (Si)-based anode active material expands and contracts due to charging and discharging of the battery. In the lithium-ion battery of the present disclosure, the lithium salt in the electrolyte solution containing the predetermined components has a relatively low concentration, which suppresses cracking of the SEI due to the expansion and contraction, thereby improving the cycle characteristics.

The Si-based anode active material is not particularly limited as long as it contains silicon and can act as the anode active material. Examples of the Si-based anode active material include pure silicon, silicon alloys (e.g., alloys of Si with one or more metals selected from the group consisting of Sn, Ti, Fe, Ni, Cu, Co, and Al), porous silicon, silicon clathrate compounds, silicon oxides, and combinations thereof. The Si-based anode active material may be one type alone, or two or more types in combination.

The Si-based anode active material may be either amorphous or crystalline. The crystalline phase contained in Si is not particularly limited.

The Si-based anode active material may particularly be crystalline silicon.

The anode active material layer may or may not contain an anode active material other than the Si-based anode active material.

The content of the Si-based anode active material in the anode active material layer is not particularly limited, and can be set as appropriate in consideration of a desired battery capacity etc.

### Conductive Aid

The conductive aid may be, for example, a carbon material, metal particles, or a combination thereof. The carbon material may be, for example, a non-fibrous carbon material such as acetylene black (AB) or Ketjen black (KB); a fibrous carbon material such as vapor grown carbon fiber (VGCF), carbon nanotube (CNT), or carbon nanofiber (CNF); or a combination thereof. The metal particles may be, for example, nickel, copper, iron, stainless steel, or a combination thereof.

The content of the conductive aid in the anode active material layer is not particularly limited, and can be set as appropriate in consideration of a desired electronic conductivity etc.

### Binder

The binder may be, for example, a rubber-based binder such as butadiene rubber, hydrogenated butadiene rubber, styrene butadiene rubber (SBR), hydrogenated styrene butadiene rubber, nitrile butadiene rubber, hydrogenated nitrile butadiene rubber, acrylate butadiene rubber (ABR), or ethylene propylene rubber; a fluoride-based binder such as polyvinylidene difluoride (PVDF), polyvinylidene difluoride-polyhexafluoropropylene copolymer (PVDF-HFP), polytetrafluoroethylene, or fluororubber; a polyolefin-based thermoplastic resin such as polyethylene, polypropylene, or polystyrene; an imide-based resin such as polyimide or polyamideimide; an amide-based resin such as polyamide; an acrylic resin such as polymethyl acrylate or polyethyl acrylate; a methacrylic resin such as polymethyl methacrylate or polyethyl methacrylate; or a combination thereof.

The content of the binder in the anode active material layer is not particularly limited, and can be set as appropriate in consideration of desired binding properties etc.

### Separator Layer

The separator layer is not particularly limited as long as it has a function of electrically isolating the cathode active material layer and the anode active material layer, and may be made of a known material.

### Cathode Active Material Layer

The cathode active material layer contains a cathode active material, and may optionally contain a conductive aid, a binder, etc. These components may be known materials.

### Electrolyte Solution

In the lithium-ion battery of the present disclosure, the anode active material layer, the separator layer, and the cathode active material layer are impregnated with the electrolyte solution. The electrolyte solution contains (A) lithium bis(fluorosulfonyl)imide (LiFSI) and (B) N,N-dimethyltrifluoromethanesulfonamide (DMeTFSA). The component (A) can supply lithium ions as a lithium salt. The component (B) can function as a solvent to dissolve the component (A).

In the lithium-ion battery of the present disclosure, the molar ratio of the component (A) to the component (B) is 1/16 or more and 1/4 or less. Thus, the relatively low concentration of the lithium salt (LiFSI) in the electrolyte solution can improve the cycle characteristics of the battery.

The molar ratio of the component (A) to the component (B) may be 1/15 or more, 1/14 or more, 1/13 or more, 1/12 or more, 1/11 or more, 1/10 or more, 1/9 or more, or 1/8 or more, and may be 1/5 or less, 1/6 or less, 1/7 or less, or 1/8 or less. The molar ratio may be 1/15 or more and 1/5 or less, 1/14 or more and 1/6 or less, 1/13 or more and 1/7 or less, or 1/12 or more and 1/8 or less. Thus, the cycle characteristics of the battery can be improved effectively.

In the lithium-ion battery of the present disclosure, the electrolyte solution may or may not contain components other than the component (A) and the component (B). The total mass of the component (A) and the component (B) in the electrolyte solution may be greater than the mass of each of the other components that may be contained in the electrolyte solution. In other words, the component (A) and the component (B) may be main components rather than additives in the electrolyte solution. Specifically, the total mass of the component (A) and the component (B) in the electrolyte solution may be 50% by mass or more, 60% by mass or more, 70% by mass or more, 80% by mass or more, 90% by mass or more, 95% by mass or more, 99% by mass or more, or 100% by mass.

The other components are not particularly limited, and examples thereof include a lithium salt other than the component (A) and a solvent other than the component (B).

### Other Configurations

As illustrated in FIG. 1, the lithium-ion battery 1 of the present disclosure may further include an anode current collector layer 10 and a cathode current collector layer 50. In this case, the lithium-ion battery 1 of the present disclosure may include the anode current collector layer 10, the anode active material layer 20, the separator layer 30, the cathode active material layer 40, and the cathode current collector layer 50 in the stated order. The materials of the anode current collector layer and the cathode current collector layer are not particularly limited, and examples thereof include copper and aluminum, respectively.

### Example 1

### Formation of Anode Active Material Layer

Crystalline Si serving as a silicon (Si)-based anode active material, polyimide (PI) serving as a binder, and Ketjen black (KB) and vapor grown carbon fiber (VGCF) serving as conductive aids were added to a dispersion medium. The contents of solid components were 82:12:5:1 in mass ratio. The solid components were dispersed in the dispersion medium to obtain an anode mixture slurry. The obtained slurry was applied onto a copper (Cu) foil serving as an anode current collector layer by blade coating. The dispersion medium in the applied slurry was removed by drying to form an anode active material layer on the anode current collector layer. The coating weight of the anode active material layer was 1.0 mg/cm².

### Fabrication of Battery

A laminate of the anode current collector layer and the anode active material layer, a separator layer, and lithium (Li) metal serving as a counter electrode were laminated in the stated order and impregnated with an electrolyte solution to fabricate a battery of Example 1. The electrolyte solution was composed of LiFSI and DMeTFSA, and the molar ratio of LiFSI to DMeTFSA was 1/16.

### Evaluation

The obtained battery was first charged at 0.1 C, maintained at 0.5 V for 12 hours, and then discharged to 1.5 V. At a first cycle, constant current (CC) charging was performed at 0.1 C until the cumulative capacity reached 1000 mAh/g or a cutoff potential of 10 mV was reached, and then constant current/constant voltage (CCCV) discharging was performed at 0.5 C to 1.5 V to check the discharge capacity. Then, the operation was repeated in a manner that CC charging was performed at 0.1 C until the cumulative capacity reached 1000 mAh/g or the cutoff potential of 10 mV was reached and then CC discharging was performed at 0.1 C to 1.5 V. At a 100th cycle, CC charging was performed at 0.1 C until the cumulative capacity reached 1000 mAh/g or the cutoff potential of 10 mV was reached, and then CCCV discharging was performed at 0.5 C to 1.5 V to check the discharge capacity. The discharge capacity retention rate at the 100th cycle was calculated from the discharge capacity at the first cycle and the discharge capacity at the 100th cycle. The average coulombic efficiency was also calculated. All the charging and discharging were carried out at 25° C. In Example 1 and Examples 2 to 4 described later, two batteries were fabricated for each example and evaluation was conducted twice.

### Examples 2 to 4

Batteries of Examples 2 to 4 were fabricated and evaluated in the same manner as in Example 1, except that the molar ratio of LiFSI to DMeTFSA was changed as shown in Table 1.

### Reference Example and Comparative Examples 1 to 4

Batteries of Reference Example and Comparative Examples 1 to 4 were fabricated and evaluated in the same manner as in Example 1, except that the lithium salt and the solvent in the electrolyte solution and the concentration of the electrolyte solution were changed as shown in Table 1.

### Comparative Examples 5 to 8

### Fabrication of Battery

Batteries of Comparative Examples 5 to 8 were fabricated in the same manner as in Example 1, except that the anode active material layer was made of Li metal and the molar ratio of LiFSI to DMeTFSA was changed as shown in Table 1.

### Evaluation

The average coulombic efficiency up to the 20th cycle was calculated by repeating deposition at 0.5 mAh/cm² for 1 hour and dissolution to a cutoff potential of 0.5 V. When a micro-short circuit occurred, the average coulombic efficiency up to that point was calculated. Two batteries were fabricated for each example and evaluation was conducted twice.

TABLE 1

| | Anode active | | Li salt/solvent (molar ratio) |
|---|---|---|---|
| | material | Electrolyte solution | ([M]) |
| Example 1 | Si | LiFSI/DMeTFSA | 1/16 |
| | | | (—) |
| Example 2 | Si | LiFSI/DMeTFSA | 1/12 |
| | | | (0.62) |
| Example 3 | Si | LiFSI/DMeTFSA | 1/8 |
| | | | (0.90) |
| Example 4 | Si | LiFSI/DMeTFSA | 1/4 |
| | | | (1.67) |
| Reference | Si | LiPF₆/EC (20 vol %)-DMC (30 vol %)-EMC (40 vol %)-FEC (10 vol %) | — |
| Example | | | (1.2) |
| Comparative | Si | LiFSI/EC (20 vol %)-DMC (30 vol %)-EMC (40 vol %)-FEC (10 vol %) | — |
| Example 1 | | | (1.2) |
| Comparative | Si | LiFSI/EC (20 vol %)-DMC (30 vol %)-EMC (40 vol %)-FEC (10 vol %) + 100 vol % TTE | — |
| Example 2 | | | (4.0) |
| Comparative | Si | LiFSI/FEMC | — |
| Example 3 | | | (1.2) |
| Comparative | Si | LiFSI/FEMC + 50 vol % HFE | — |
| Example 4 | | | (4.0) |
| Comparative | Li | LiFSI/DMeTFSA | 1/12 |
| Example 5 | | | (0.62) |
| Comparative | Li | LiFSI/DMeTFSA | 1/8 |
| Example 6 | | | (0.90) |
| Comparative | Li | LiFSI/DMeTFSA | 1/4 |
| Example 7 | | | (1.67) |
| Comparative | Li | LiFSI/DMeTFSA | 1/3 |
| Example 8 | | | (2.16) |

In Table 1, the notations for the solvents in the electrolyte solution represent the following compounds:
EC: ethylene carbonate
DMC: dimethyl carbonate
EMC: ethyl methyl carbonate
FEC: fluoroethylene carbonate
TTE: 1,1,2,2-tetrafluoroethyl-2,2,2-trifluoroethyl ether
HFE: hydrofluoroether
FEMC: methyl 2,2,2-trifluoroethyl carbonate

The concentration of the electrolyte solution is given as Li salt/solvent (molar ratio) in the electrolyte solution and/or a value in molar units (M, mol/L) (in parentheses).

The evaluation results of the batteries of the examples are shown in FIGS. 2 to 5.

FIG. 2 is a graph showing the evaluation results of the batteries of Examples 1 to 4 (arranged from the left in numerical sequence), that is, the discharge capacity retention rates and the average coulombic efficiencies at the 100th cycle. As shown in FIG. 2, the evaluation results were good in the batteries of the examples in which the molar ratio of LiFSI to DMeTFSA was 1/16 or more and 1/4 or less. In particular, the evaluation results were even better in the batteries of Examples 2 and 3 in which the molar ratio was 1/12 or more and 1/8 or less.

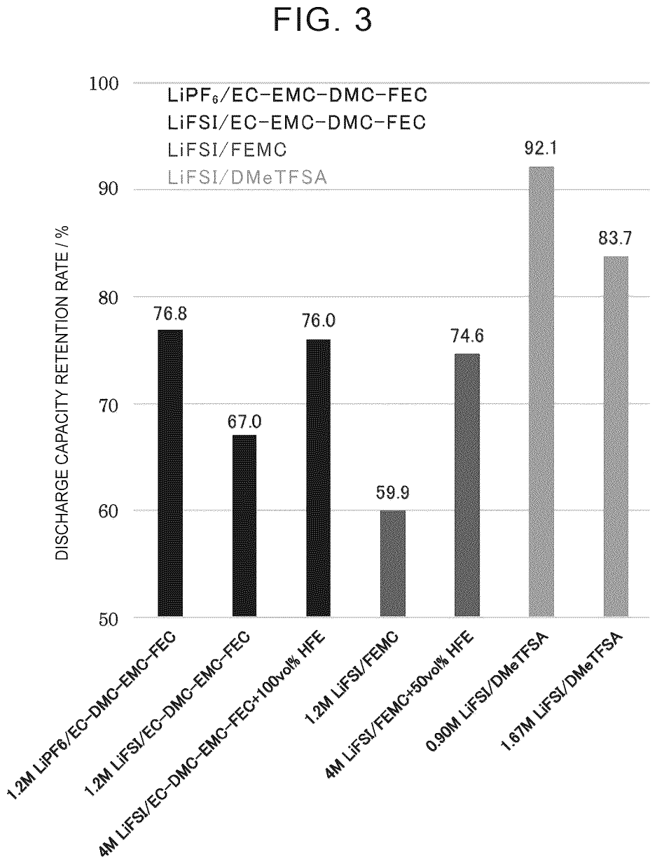

FIG. 3 is a graph showing the discharge capacity retention rates at the 100th cycle for the batteries of Example 3 (second from the right), Example 4 (rightmost), Reference Example (leftmost), and Comparative Examples 1 to 4 (second to fifth from the left in numerical sequence). As shown in FIGS. 2 and 3, in the batteries of the examples, when the lithium salt concentration in the electrolyte solution was a predetermined value or more, the discharge capacity retention rate at the 100th cycle decreased. In the batteries of the comparative examples, the discharge capacity retention rate at the 100th cycle increased along with an increase in the lithium salt concentration in the electrolyte solution. This indicates that the relationship between the lithium salt concentration in the electrolyte solution and the cycle characteristics in the lithium-ion battery of the present disclosure that includes the electrolyte solution containing the specific combination, that is, LiFSI and DMeTFSA, is different from those of the other batteries.

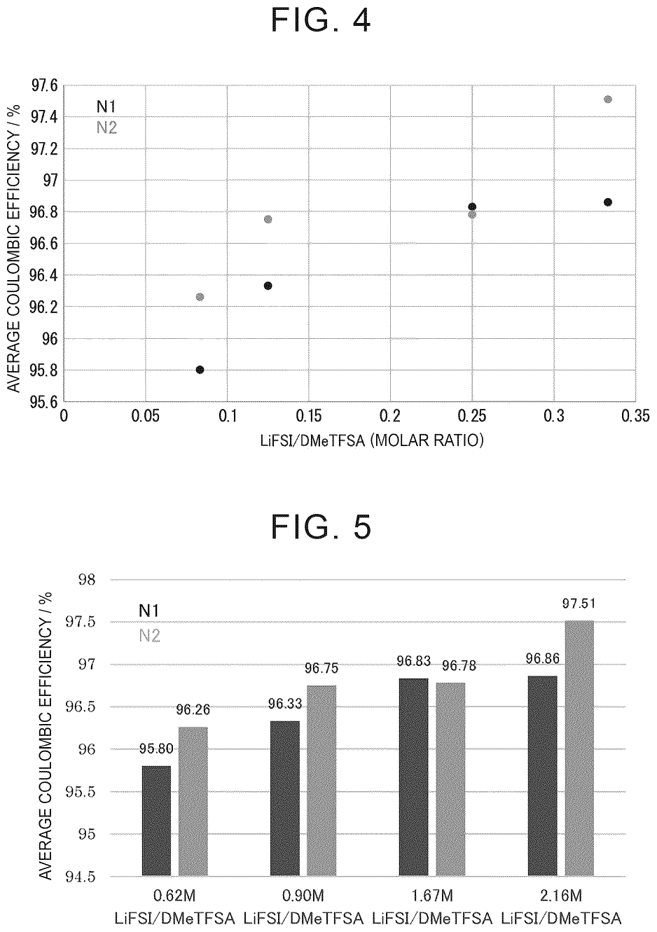

FIGS. 4 and 5 are graphs showing the average coulombic efficiencies of the batteries of Comparative Examples 5 to 8 (arranged from the left in numerical sequence). As shown in FIGS. 4 and 5, in the batteries of Comparative Examples 5 to 8 in which the type of the anode active material was changed, that is, the anode active material layer was made of Li metal, the average coulombic efficiency increased along with an increase in the lithium salt concentration in the electrolyte solution. As shown in FIG. 2, in the batteries of the examples, when the lithium salt concentration in the electrolyte solution was a predetermined value or more, the average coulombic efficiency decreased. This indicates that the relationship between the lithium salt concentration in the electrolyte solution and the cycle characteristics in the lithium-ion battery of the present disclosure that includes the combination of the silicon-based anode active material and the specific electrolyte solution, that is, includes the silicon-based anode active material and the electrolyte solution containing LiFSI and DMeTFSA, is different from those of the other batteries.

What is claimed is:

1. A lithium-ion battery comprising an anode active material layer, a separator layer, and a cathode active material layer in the stated order, wherein
the anode active material layer, the separator layer, and the cathode active material layer are impregnated with an electrolyte solution,
the anode active material layer contains a silicon-based anode active material,
the electrolyte solution contains (A) lithium bis(fluorosulfonyl)imide and (B) N,N-dimethyltrifluoromethanesulfonamide, and
a molar ratio of a component (A) to a component (B) is 1/16 or more and 1/4 or less.

2. The lithium-ion battery according to claim 1, wherein the molar ratio is 1/12 or more and 1/8 or less.

3. The lithium-ion battery according to claim 1, wherein a total mass of the component (A) and the component (B) in the electrolyte solution is greater than a mass of each of other components contained in the electrolyte solution.
